(19) United States
(12) Patent Application Publication
(10) Pub. No.: US 2022/0153558 A1
(43) Pub. Date: May 19, 2022

(54) HOIST REPLACEMENT FRAME

(71) Applicant: Jeff Anderson, Murfreesboro, TN (US)

(72) Inventor: Jeff Anderson, Murfreesboro, TN (US)

(21) Appl. No.: 17/505,704

(22) Filed: Oct. 20, 2021

Related U.S. Application Data
(60) Provisional application No. 63/115,126, filed on Nov. 18, 2020.

(51) Int. Cl. B66C 7/12; B66C 11/08

(52) U.S. Cl. CPC B66C 7/12; B66C 11/08

(57) ABSTRACT

A hoist transport and replacement frame, in one example includes, among other things, a base structure, at least one vertical support extending upward from the base structure, and at least one horizontal beam fixed to the at least one vertical support. The at least one horizontal beam includes a hoist support structure configured to mount a trolley hoist. The base structure, the at least one vertical support, and the at least one horizontal beam are selectively moveable together as a unit to transport trolley hoists.

### TECHNICAL FIELD

This disclosure relates generally to a movable frame that is used to replace and/or transport a trolley hoist.

### BACKGROUND

A trolley hoist is used to lift heavy or large objects for movement around a production work space. The production work space can become congested when multiple hoists are being utilized. The process of removing or replacing a hoist can be cumbersome to accomplish without damaging the hoist unit itself. There is a high demand to be able to remove, replace, or transport the hoist safely and easily while ensuring the integrity of the equipment as well as ensuring safety of the technician. Traditionally, a fork lift has been used to hold the hoist, or the hoist would be removed from an I-Beam support and placed onto a pallet. This can result in damage to components and electrical cords associated with the hoist.

### SUMMARY

An apparatus according to an exemplary aspect of the present disclosure includes, among other things, a base structure, at least one vertical support extending upward from the base structure, and at least one horizontal beam fixed to the at least one vertical support. The at least one horizontal beam includes a hoist support structure configured to mount a trolley hoist. The base structure, the at least one vertical support, and the at least one horizontal beam are selectively moveable together as a unit.

In a further non-limiting embodiment of the foregoing apparatus, the hoist support structure comprises opposing ledge surfaces of the at least one horizontal beam.

In a further non-limiting embodiment of any of the foregoing apparatus, the at least one horizontal beam comprises an I-Beam.

In a further non-limiting embodiment of any of the foregoing apparatus, the at least one vertical support is rotatable relative to the base structure.

In a further non-limiting embodiment of any of the foregoing apparatus, the at least one vertical support comprises at least a first tube fixed to the base structure and a second tube that is selectively rotatable relative to the first tube.

In a further non-limiting embodiment of any of the foregoing apparatus, the second tube is selectively movable in a vertical direction relative to the first tube.

In a further non-limiting embodiment of any of the foregoing apparatus, a lock feature prevents relative rotation of the at least one vertical support.

In a further non-limiting embodiment of any of the foregoing apparatus, the at least one vertical support comprises at least a first pair of vertical legs connected to each other by a first header and a second pair of vertical legs connected to each other by a second header, and wherein the first pair of vertical legs are fixed to the base structure opposite from the first header and the second pair of vertical legs are fixed to the base structure opposite from the second header, and wherein the first and second pairs of vertical legs are spaced apart from each other in horizontal direction.

In a further non-limiting embodiment of any of the foregoing apparatus, the at least one horizontal beam is fixed to the first and second headers.

In a further non-limiting embodiment of any of the foregoing apparatus, the base structure includes at least one set of forklift pockets.

In a further non-limiting embodiment of any of the foregoing apparatus, the at least one horizontal beam includes a positioning lip to align the at least one horizontal beam with an adjacent beam.

In a further non-limiting embodiment of any of the foregoing apparatus, the at least one horizontal beam includes at least one trolley stop to prevent the trolley hoist from disengaging from the at least one horizontal beam.

In a further non-limiting embodiment of any of the foregoing apparatus, at least one holder supports cords, chains, and/or other trolley hoist components.

A method according to still another exemplary aspect of the present disclosure includes, among other things: providing a base structure, at least one vertical support extending upward from the base structure, and at least one horizontal beam fixed to the at least one vertical support, wherein the at least one horizontal beam includes a hoist support structure configured to mount a trolley hoist; and moving the base structure, the at least one vertical support, and the at least one horizontal beam together as a unit from one location to another location.

In a further non-limiting embodiment of the foregoing method, the method further includes:
(a) aligning the at least one horizontal beam with an adjacent horizontal beam; and (b) moving the trolley hoist from the at least one horizontal beam to the adjacent horizontal beam, or moving trolley hoist from the adjacent horizontal beam to the at least one horizontal beam.

In a further non-limiting embodiment of any of the foregoing methods, the method further includes: (a1) locking the at least one horizontal beam to the adjacent horizontal beam after step (a); and (c) unlocking the at least one horizontal beam from the adjacent horizontal beam subsequent to step (b).

In a further non-limiting embodiment of any of the foregoing methods, steps (b) and (c) further include: first moving a first trolley hoist from the adjacent horizontal beam to the at least one horizontal beam, unlocking the at least one horizontal beam from the adjacent horizontal beam,

rotating the at least one horizontal beam to align an opposite end of the at least one horizontal beam with the adjacent horizontal beam, locking the at least one horizontal beam to the adjacent horizontal beam, moving a second trolley hoist from the at least one horizontal beam to the adjacent horizontal beam, and unlocking the at least one horizontal beam from the adjacent horizontal beam.

In a further non-limiting embodiment of any of the foregoing methods, step (b) further includes moving a first trolley hoist from the adjacent horizontal beam to the at least one horizontal beam to transport the first trolley beam to another location.

In a further non-limiting embodiment of any of the foregoing methods, step (a) includes using a positioning lip to align the at least one horizontal beam with the adjacent horizontal beam.

In a further non-limiting embodiment of any of the foregoing methods, the at least one vertical support is rotatable relative to the base structure and/or is moveable in a vertical direction relative to the base structure.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a perspective view of a rotating hoist transport frame.

FIG. 2 illustrates a perspective view of a fixed hoist transport frame.

FIG. 3 illustrates a trolley hoist to be used on the hoist transport frame

FIGS. 4a-4g illustrate a method of replacing a trolley hoist using a hoist transport frame.

FIG. 5 illustrates a perspective view of another fixed hoist transport frame.

### DETAILED DESCRIPTION

This disclosure details exemplary trolley hoist transport frames. The frames can be used to transport a new trolley hoist to an existing hoist location for replacement, or the frames can be used to transport a trolley hoist from one location to another.

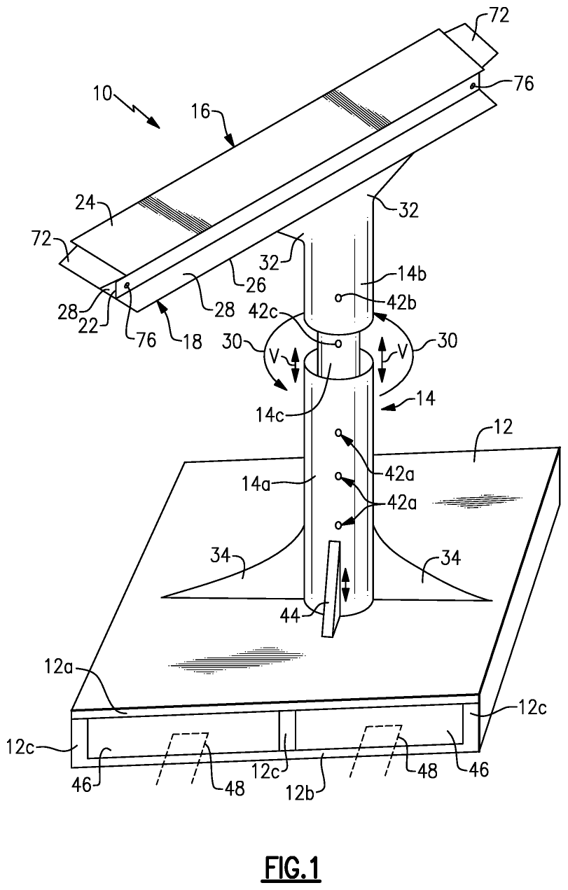

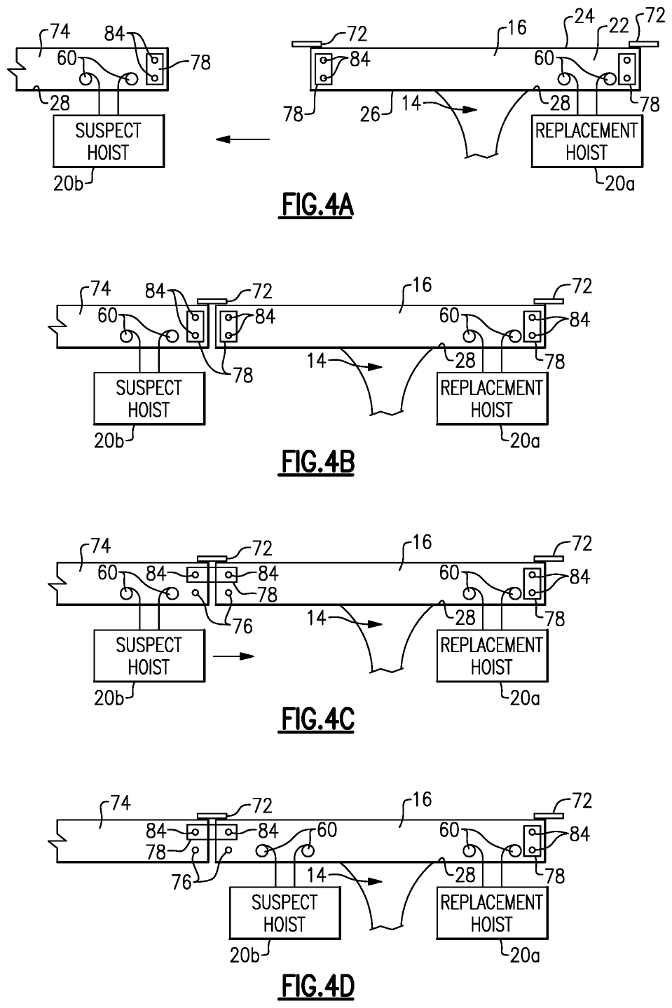

FIG. 1 shows a first example of a hoist replacement frame 10. The hoist replacement frame 10 includes a base structure 12, at least one vertical support 14 extending upward from the base structure 12, and at least one horizontal beam 16 fixed to the at least one vertical support 14. The at least one horizontal beam 16 includes a hoist support structure 18 configured to mount a trolley hoist 20 (FIG. 3). The base structure 12, the at least one vertical support 14, and the at least one horizontal beam 16 are selectively moveable together as a unit to transport trolley hoists 20. The unit can be moved easily around a production area without damaging the trolley hoists 20 supported by the unit.

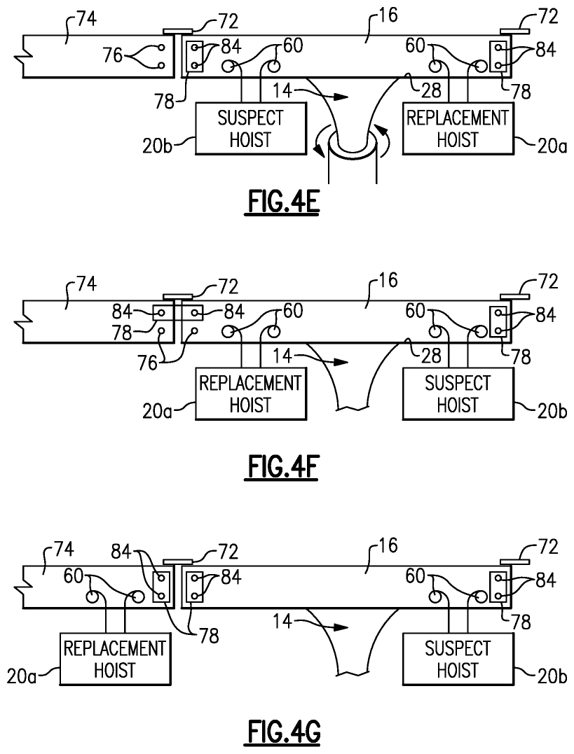

In one example, the at least one horizontal beam 16 comprises an I-Beam having a vertical wall 22 extending between upper 24 and lower 26 horizontal plates to for an I-shaped cross-section. In one example, the hoist support structure 18 comprises opposing ledge surfaces 28 of the lower horizontal plate 26 of the I-Beam (see FIG. 4a). The trolley hoist 20 is supported on these surfaces 28 for movement along the beam 16 as known.

In the example shown in FIG. 1, the at least one vertical support 14 is rotatable relative to the base structure 12. In this example, the vertical support 14 comprises a first pipe or tube 14a fixed to the base structure 12 and a second pipe or tube 14b that is selectively rotatable relative to a support rod 14c as indicated by arrows 30. In one example, the support rod 14c comprises a solid rod that has one end received within the first tube 14a and an opposite end received within the second tube 14b. The second tube 14b swivels or rotates on the support rod 14c to be able to align the I-beam 16 with an adjacent beam. By rotating the second tube 14b relative to the base structure 12 by swiveling on the support rod 14c, the horizontal beam 16 can be rotated to allow one trolley hoist to be easily swapped out for another trolley hoist. This will be discussed in greater detail below.

The first 14a and second 14b tubes are positioned in a telescoping relationship with the support rod 14c such that one of the support rod 14c has a smaller outermost dimension than the first 14a and second 14b tubes. Additionally, in one example, the second tube 14b is received over the support rod 14c and within the second tube 14b in telescoping relationship. Thus, the second tube 14b has a smaller outermost dimension than the first tube 14a. Further, while FIG. 1 shows the second tube 14b being received within the first tube 14a, the reverse configuration could also be used.

In one example, the second 14b tube is selectively movable in a vertical direction V relative to the base structure 12 to adjust a height of the vertical support 14. In the example shown in FIG. 1, the second tube 14b is selectively movable in the vertical direction V relative to the first tube 14a and the support rod 14c. This allows the height of the horizontal beam 16 to be adjusted for alignment purposes.

In one example, the rotating tube 14b is fixed to the horizontal beam 16 such that, when the tube 14b is rotated, the beam and tube 14b rotate together relative to the base structure 12. In one example, an upper end of the tube 14b is fixed to the lower plate 26 of the horizontal beam 16 by welding, fastening, etc. Beam supports 32 are positioned on opposing sides of the tube 14b and extend to the beam 16 to provide increased stability. Additional frame supports 34 can also be used to increase stability between the fixed tube 14a and the base structure 12.

In one example, a lock feature 40 is used to selectively prevent relative rotation of the at least one vertical support 14 relative to the base structure 12 and to prevent vertical movement of the second tube 14b relative to the first tube 14a. In the example shown in FIG. 1, each of the first 14a and second 14b tubes and the support rod 14c include a respective plurality of positioning holes 42a, 42b, 42c. The holes 42a, 42b, 42c are discrete holes that are spaced apart from each other in a vertical direction along a length of the tubes 14a, 14b and support rod 14c. To lock the tubes 14a, 14b and support rod 14c together, a locking pin 44 is inserted through a set of aligned holes 42a, 42b, 42c. This prevents any rotation between the tubes 14a, 14b and rod 14c and fixes the vertical support 14 to a desired height. To unlock the tubes 14a, 14b and rod 14c, the pin 44 is withdrawn from the holes 42a, 42b, 42c and then the second tube 14b can be rotated to reposition the horizontal beam 16, and/or the second tube 14b can be raised/lowered vertically to adjust the height of the beam 16. Once the beam 16 is in the desired position, the pin 44 is inserted into the selected set of aligned holes 42a, 42b, 42c.

In one example, the base structure 12 comprises a rigid box or plate structure. Pockets 46 are provided within the base structure 12 to receive forklift arms 48. To form the pockets 46, the base structure 12 includes an upper plate 12a, lower plate 12b, and vertical wall portions 12c extending between the upper 12a and lower 12b plates. In the example shown, two wall portions 12c are at opposing edges of the upper 12a and lower 12b plates, and another wall portion is at a center location of the upper 12a and lower 12b plates to form two pockets 46.

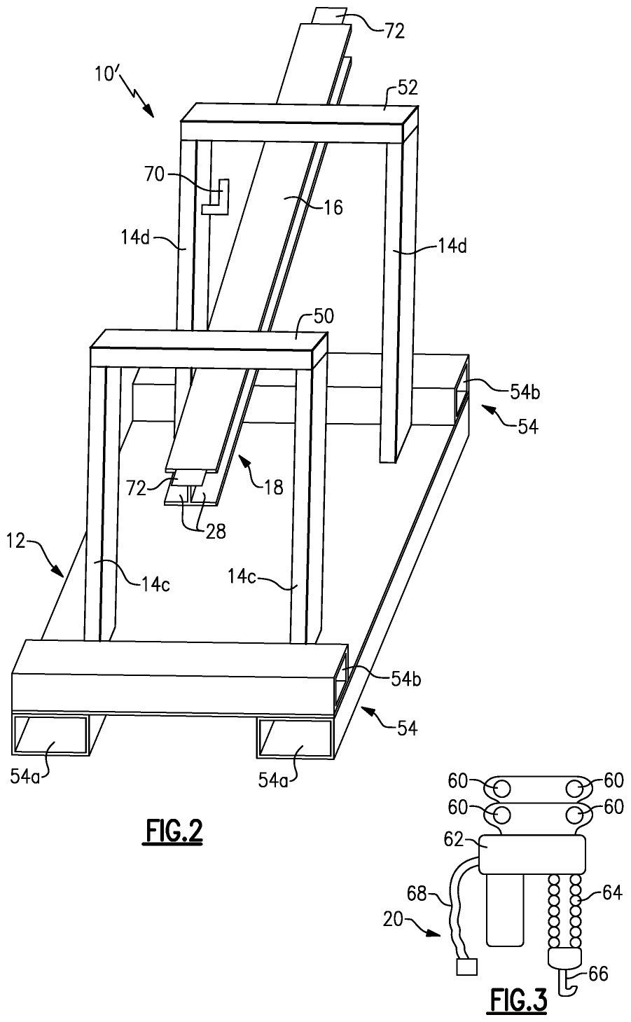

In another example shown in FIG. 2, the at least one vertical support 14 of a fixed hoist frame 10′ comprises at least a first pair of vertical legs 14c connected to each other by a first header 50 and a second pair of vertical legs 14d connected to each other by a second header 52. The first pair of vertical legs 14c are fixed to the base structure 12 opposite from the first header 50 and the second pair of vertical legs 14d are fixed to the base structure 12 opposite from the second header 52. The pairs of vertical legs 14c, 14 and their respective headers 50, 52 form a C-shape or a U-shape. The first 14c and second 14d pairs of vertical legs are spaced apart from each other in the horizontal direction to provide stability for the beam 16. The horizontal beam 16 is fixed to the first 50 and second 52 headers by welding, fastening, etc. In one example, the horizontal beam 16 is similar to that described above with regard to FIG. 1. The beam 16 thus provides the hoist support structure 18 as opposing ledge surfaces 28 of the lower horizontal plate 26 of the I-Beam. In the example of FIG. 2, the base structure 12 is comprised of a plurality of forklift pockets 54. In one example a first pair of pockets 54a are positioned ninety degrees relative to a second pair of pockets 54b. This allows the forklift to pick up the hoist transport frame 10′ from different directions. Each of the pockets 54 is formed by upper and lower walls 56 connected by a pair of side walls 58. In one example, the lower ends of the first 14c and second 14d pairs of vertical legs are fixed to the pockets 54. Optionally, a base plate structure, such as that shown in FIG. 1, could also be used with the pockets 54.

FIG. 3 shows a schematic example of a trolley hoist 20. The hoist 20 includes pairs of rollers 60 that run along the ledge surfaces 28 of the beam 16. A control module 62 with a controller, gearbox, motor, etc. is used to control movement of the hoist 20 along the beam 16 as known. A chain 64 and load hook 66 are used to pick up and support the objects that are to be moved around the production work space. Electrical cords 68 and other components are also part of the hoist assembly.

In one example, the vertical support 14 includes one or more holders 70 for supporting cords 68, chains 54, and/or other trolley hoist components during transport of the trolley hoist 20 with the frame. In one example, the holder 70 comprises a hook or retaining arm having a J-shape or L-shape over which components can be hung and held in place. The holders 70 can be used in the configuration shown in FIG. 1 or 2, for example.

In each example, the beam 16 includes a positioning lip 72 to align the horizontal beam 16 with an adjacent beam 74. The beam 16 also includes positioning and stop holes 76 that are used to fix the beam 16 to the adjacent beam 74 such that trolley hoists can be moved back and forth between the transport beam 16 and the working beam 74. Trolley stops 78 (FIG. 4a) are associated with the stop holes 76 and receive fasteners 84 that are used to prevent the trolley hoist 20 from disengaging from the beams 16, 74.

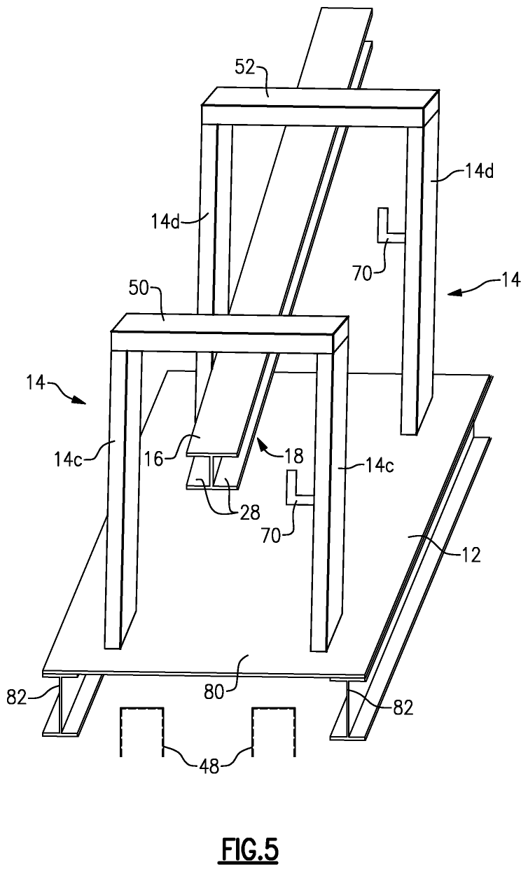

FIG. 5 shows another example of a hoist frame 10″ that is similar to FIG. 2, but includes a different base structure 12. In this example, the base structure 12 is comprised of a base plate 80 and a pair of beams 82 that are positioned at edges of the base plate 80. The first pair of vertical legs 14c and the second pair of vertical legs 14d are connected to the base plate 80. The forklift arms 48 can lift the base plate 80 by extending underneath the base plate 80 between the beams 82. FIG. 5 also shows a configuration with a plurality of holders 70.

The subject disclosure also provides a method of transporting a new trolley hoist 20a on a frame 10, 10′ to the beam 74 of an existing hoist location for replacement of an old trolley hoist 20b. The frames 10, 10′ can also be used to transport a trolley hoist 20 from one location to another. An example of the transport methods is described with regard to FIGS. 4a-4g. In each transport example, the method utilizes a hoist frame 10, 10′, 10″ that includes the base structure 12, the vertical support 14 extending upward from the base structure 12, and the horizontal beam 16. The base structure 12, the at least one vertical support 14, and the at least one horizontal beam 16 are moved together as a unit from one production location to another production location.

As shown in FIG. 4a, the method first includes aligning the transport beam 16 with an adjacent horizontal working beam 74. The positioning lip 72 from the transport beam 16 of the replacement hoist frame is aligned with an upper surface of the working beam 74 as shown in FIG. 4b. This aligns the transport beam 16 with the working beam 74 to allow the old trolley hoist 20b to be off-loaded onto the transport beam 16. Before the hoist 20b can be off-loaded, the beams 16, 74 must be locked together. Once the beams 16, 74 are aligned, the trolley stops 78 are unfastened from their respective beams 16, 74. One trolley stop 78 is then used to fix the two beams 16, 74 together. One end of the trolley stop 78 is fixed to the working beam 74 with a fastener 84 and the opposite end of the trolley stop 78 is fixed to the transport beam 16 with another fastener 84 as shown in FIG. 4c.

Once the beams 16, 74 are locked together, the old trolley hoist 20b is moved from the working beam 74 to the transport beam 16 as shown in FIG. 4d. At this time, both the old trolley hoist 20b and the new/replacement trolley hoist 20a are supported on the transport beam 16. Once the old hoist 20b is on the transport beam 16, the trolley stop 78 is unfastened from both beams 16, 74 and the transport beam 16 is rotated to align an opposite end of the transport beam 16 with the working beam as shown in FIG. 4e. The beam 16 can be rotated using the rotating configuration as shown in FIG. 1, or by using a forklift to rotate the fixed configurations as shown in FIGS. 2 and 5.

After rotation, the transport beam 16 is positioned with the positioning lip 72 and is locked to the working beam 74 (FIG. 4f) with the trolley stop 78 as described above. Next, the new trolley hoist 20b is moved from the transport beam 16 to the working beam 74 as shown in FIG. 4g. Then, the transport beam 16 is unlocked from the working beam 74 by unfastening the trolley stop 78. The trolley stops 78 for each beam 16, 74 can then be fastened back in place. The hoist frame unit of the transport beam 16, vertical support 16, and base structure 12 can then be used to move the old trolley hoist 20b to another location or to a repair shop, for example.

The subject disclosure provides a method and apparatus that can be used to remove, replace, or transport trolley hoists safely and easily while ensuring the integrity of the equipment as well as ensuring safety of the technicians. The frames can be used to swap out trolley hoists in need of repair and exchange them with a working trolley hoist in a safe manner. The fixed hoist replacement frame configuration can be lifted up to and aligned with the working beam of the old trolley hoist with a fork lift. The hoist is then transferred to the transport beam 16 and the hoist can be lowered, the frame turned around with the forklift, and then lifted back up to transfer over the new working hoist. The rotating hoist replacement frame configuration provides additional advantages in that the height of the transport beam can be easily adjusted, and the beam can be easily rotated to exchange the hoists.

Although a specific component relationship is illustrated in the figures of this disclosure, the illustrations are not intended to limit this disclosure. In other words, the placement and orientation of the various components shown could vary within the scope of this disclosure. In addition, the various figures accompanying this disclosure are not necessarily to scale, and some features may be exaggerated or minimized to show certain details of a particular component.

The preceding description is exemplary rather than limiting in nature. Variations and modifications to the disclosed examples may become apparent to those skilled in the art that do not necessarily depart from the essence of this disclosure. Thus, the scope of legal protection given to this disclosure can only be determined by studying the following claims.

What is claimed is:

1. An apparatus, comprising:
a base structure;
at least one vertical support extending upward from the base structure;
at least one horizontal beam fixed to the at least one vertical support, wherein the at least one horizontal beam includes a hoist support structure configured to mount a trolley hoist; and
wherein the base structure, the at least one vertical support, and the at least one horizontal beam are selectively moveable together as a unit.

2. The apparatus according to claim 1, wherein the hoist support structure comprises opposing ledge surfaces of the at least one horizontal beam.

3. The apparatus according to claim 2, wherein the at least one horizontal beam comprises an I-Beam.

4. The apparatus according to claim 1, wherein the at least one vertical support is rotatable relative to the base structure.

5. The apparatus according to claim 4, wherein the at least one vertical support comprises at least a first tube fixed to the base structure and a second tube that is selectively rotatable relative to the first tube.

6. The apparatus according to claim 4, wherein the second tube is selectively movable in a vertical direction relative to the first tube.

7. The apparatus according to claim 4, including a lock feature to prevent relative rotation of the at least one vertical support.

8. The apparatus according to claim 1, wherein the at least one vertical support comprises at least a first pair of vertical legs connected to each other by a first header and a second pair of vertical legs connected to each other by a second header, and wherein the first pair of vertical legs are fixed to the base structure opposite from the first header and the second pair of vertical legs are fixed to the base structure opposite from the second header, and wherein the first and second pairs of vertical legs are spaced apart from each other in horizontal direction.

9. The apparatus according to claim 8, wherein the at least one horizontal beam is fixed to the first and second headers.

10. The apparatus according to claim 1, wherein the base structure includes at least one set of forklift pockets.

11. The apparatus according to claim 1, wherein the at least one horizontal beam includes a positioning lip to align the at least one horizontal beam with an adjacent beam.

12. The apparatus according to claim 1, wherein the at least one horizontal beam includes at least one trolley stop to prevent the trolley hoist from disengaging from the at least one horizontal beam.

13. The apparatus according to claim 1, including at least one holder for supporting cords, chains, and/or other trolley hoist components.

14. A method comprising:
providing a base structure, at least one vertical support extending upward from the base structure, and at least one horizontal beam fixed to the at least one vertical support, wherein the at least one horizontal beam includes a hoist support structure configured to mount a trolley hoist; and
moving the base structure, the at least one vertical support, and the at least one horizontal beam together as a unit from one location to another location.

15. The method according to claim 14, including
(a) aligning the at least one horizontal beam with an adjacent horizontal beam; and
(b) moving the trolley hoist from the at least one horizontal beam to the adjacent horizontal beam, or moving trolley hoist from the adjacent horizontal beam to the at least one horizontal beam.

16. The method according to claim 15, including
(a1) locking the at least one horizontal beam to the adjacent horizontal beam after step (a); and
(c) unlocking the at least one horizontal beam from the adjacent horizontal beam subsequent to step (b).

17. The method according to claim 16, wherein steps (b) and (c) further include
first moving a first trolley hoist from the adjacent horizontal beam to the at least one horizontal beam,
unlocking the at least one horizontal beam from the adjacent horizontal beam,
rotating the at least one horizontal beam to align an opposite end of the at least one horizontal beam with the adjacent horizontal beam,
locking the at least one horizontal beam to the adjacent horizontal beam,
moving a second trolley hoist from the at least one horizontal beam to the adjacent horizontal beam, and
unlocking the at least one horizontal beam from the adjacent horizontal beam.

18. The method according to claim 15, wherein step (b) further includes moving a first trolley hoist from the adjacent horizontal beam to the at least one horizontal beam to transport the first trolley beam to another location.

19. The method according to claim 15, wherein step (a) includes using a positioning lip to align the at least one horizontal beam with the adjacent horizontal beam.

20. The method according to claim 14, wherein the at least one vertical support is rotatable relative to the base structure and/or is moveable in a vertical direction relative to the base structure.
